(19) United States
(12) Patent Application Publication
(10) Pub. No.: US 2017/0211814 A1
(43) Pub. Date: Jul. 27, 2017

(54) ELECTRIC FIREPLACE ASSEMBLY WITH HIDEAWAY DOORS

(71) Applicant: Greentouch USA, Inc., Miami, FL (US)

(72) Inventors: William Scott Bourne, Boynton Beach, FL (US); Jonathan Edward Prentice, Sanford, FL (US)

(21) Appl. No.: 15/416,839

(22) Filed: Jan. 26, 2017

Related U.S. Application Data
(60) Provisional application No. 62/287,232, filed on Jan. 26, 2016.

(51) Int. Cl. F24C 7/00; F21S 10/04; F24C 15/06

(52) U.S. Cl. CPC F24C 7/00; F24C 15/06; F21S 10/04; F21Y 2115/10

(57) ABSTRACT

An electric fireplace assembly (10) that is selectively movable between an open configuration and a closed configuration includes an assembly housing (12); and an electric fireplace (14) that is positioned substantially within the assembly housing (12). The electric fireplace (14) includes (i) a fireplace housing (24) having a first side (24A) that is spaced apart from the assembly housing (12) to define a first assembly cavity (42A); (ii) a simulated log (30) that is positioned within the fireplace housing (24); and (iii) a first fireplace door (16A) that is coupled to the fireplace housing (24). The first fireplace door (16A) is positioned substantially directly in front of the simulated log (30) to obscure a view of the simulated log (30) when the electric fireplace assembly (10) is in the closed configuration. Additionally, the first fireplace door (16A) is positioned within the first assembly cavity (42A) when the electric fireplace assembly (10) is in the open configuration.

### RELATED APPLICATION

The application claims priority on U.S. Provisional Application Ser. No. 62/287,232 filed on Jan. 26, 2016, entitled “ELECTRIC FIREPLACE ASSEMBLY WITH HIDEAWAY DOORS”. As far as is permitted, the contents of U.S. Provisional Application Ser. No. 62/287,232 are incorporated herein by reference.

### BACKGROUND

Fireplaces of various types can be installed in homes and commercial establishments as a means to provide a source of heat and for aesthetic reasons. Although traditionally such fireplaces have most often taken the form of wood-burning fireplaces and gas-burning fireplaces, electric fireplaces have become increasingly popular in recent years. An electric fireplace is typically designed to look like a traditional wood-burning fireplace, but does not actually burn wood. In certain applications, electric fireplaces can also be incorporated into a piece of furniture, such as an entertainment center, that serves other functions. In such applications, it can be desired to utilize fireplace doors to obscure the electric fireplace when not in use. However, a question arises as to what to do with the fireplace doors while the electric fireplace is being used.

### SUMMARY

The present invention is directed toward an electric fireplace assembly (also referred to herein simply as a “fireplace assembly”) that is selectively movable between an open configuration and a closed configuration. In various embodiments, the electric fireplace assembly includes an assembly housing; and an electric fireplace that is positioned substantially within the assembly housing. The electric fireplace includes (i) a fireplace housing having a first side that is spaced apart from the assembly housing to define a first assembly cavity; (ii) a simulated log that is positioned within the fireplace housing; and (iii) a first fireplace door that is coupled to the fireplace housing. The first fireplace door is positioned substantially directly in front of the simulated log to obscure a view of the simulated log when the electric fireplace assembly is in the closed configuration. Additionally, the first fireplace door is positioned within the first assembly cavity when the electric fireplace assembly is in the open configuration.

Additionally, in certain embodiments, the electric fireplace assembly further includes a first cavity door that is movably coupled to the first assembly cavity. The first cavity door can be closed such that the first fireplace door is hidden from view when the electric fireplace assembly is in the open configuration.

Further, in some embodiments, the fireplace housing has a second side that is spaced apart from the assembly housing to define a second assembly cavity. In such embodiments, the electric fireplace can further include a second fireplace door that is coupled to the fireplace housing. The second fireplace door can be positioned substantially directly in front of the simulated log to obscure a view of the simulated log when the electric fireplace assembly is in the closed configuration. Moreover, the second fireplace door can be positioned within the second assembly cavity when the electric fireplace assembly is in the open configuration.

In certain embodiments, the electric fireplace assembly further includes a second cavity door that is movably coupled to the assembly housing adjacent to the second assembly cavity. In such embodiments, the second cavity door can be closed such that the second fireplace door is hidden from view when the electric fireplace assembly is in the open configuration.

In some embodiments, the first fireplace door is removably coupled to the fireplace housing. For example, the electric fireplace assembly can further include a magnet that is secured to a back of the first fireplace door such that the first fireplace door can be magnetically coupled to the fireplace housing when the electric fireplace assembly is in the closed configuration.

Additionally, in certain embodiments, the electric fireplace further includes a heater that is positioned within the fireplace housing, the heater being configured to provide heated air which can be directed in a generally outward direction away from the fireplace housing. Further, the electric fireplace can also include a light source that is positioned within the fireplace housing, the light source being configured to generate a simulated flame within the fireplace housing.

The present invention is further directed toward an electric fireplace assembly including (A) an assembly housing including a vertically-oriented first assembly drawer; and (B) an electric fireplace that is positioned substantially within the assembly housing, the electric fireplace including (i) a fireplace housing having a first side; and (ii) a simulated log that is positioned within the fireplace housing; and wherein the first assembly drawer is positioned substantially directly adjacent to the first side of the fireplace housing.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is a front perspective view of an embodiment of an electric fireplace assembly having features of the present invention, the electric fireplace assembly being in an open configuration;

FIG. 1B is a front perspective view of the electric fireplace assembly illustrated in FIG. 1A, the electric fireplace assembly being in a closed configuration;

FIG. 1C is another front perspective view of the electric fireplace assembly illustrated in FIG. 1A, with the electric fireplace assembly being moved partially from the closed configuration toward the open configuration;

FIG. 1D is still another front perspective view of the electric fireplace assembly illustrated in FIG. 1A, with the electric fireplace assembly being moved farther from the closed configuration toward the open configuration;

FIG. 1E is yet another front perspective view of the electric fireplace assembly illustrated in FIG. 1A, with the electric fireplace assembly being moved still farther from the closed configuration toward the open configuration;

FIG. 2A is a front perspective view of another embodiment of the electric fireplace assembly having features of the present invention; and

FIG. 2B is another front perspective view of the electric fireplace assembly illustrated in FIG. 2A.

### DESCRIPTION

Embodiments of the present invention are described herein in the context of an electric fireplace assembly with hideaway fireplace doors. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application-related and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

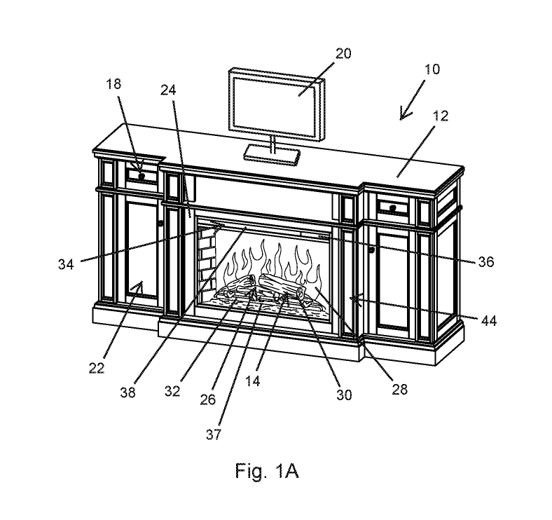

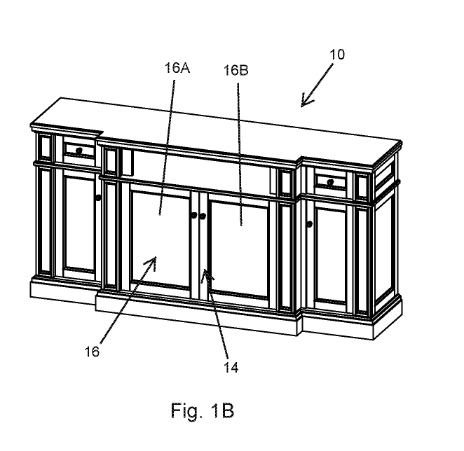

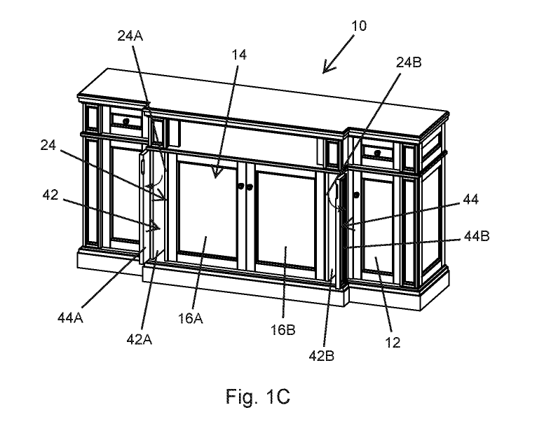

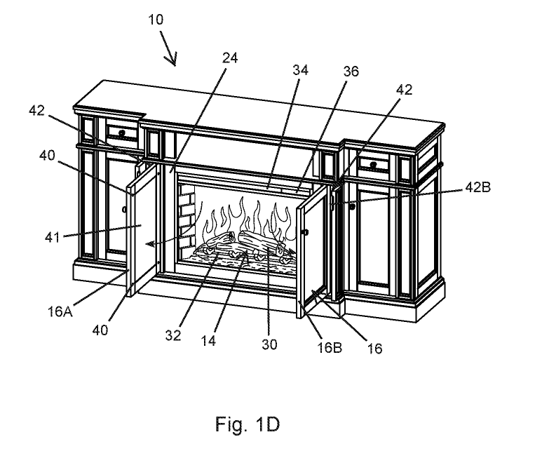

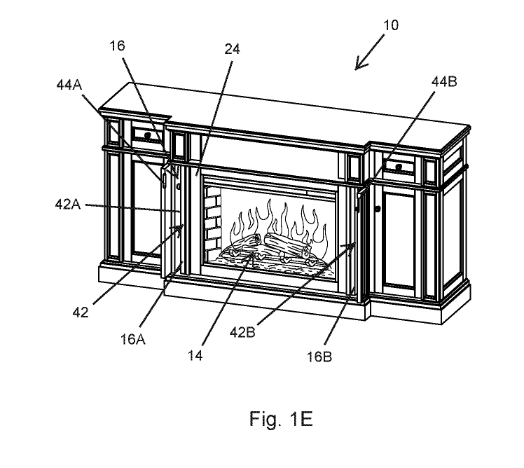

FIG. 1A is a front perspective view of an embodiment of an electric fireplace assembly 10 (also referred to herein simply as a “fireplace assembly”) having features of the present invention. The design of the fireplace assembly 10 can be varied. In certain embodiments, as illustrated in FIG. 1A, the fireplace assembly 10 includes an assembly housing 12 and an electric fireplace 14 that is positioned substantially within the assembly housing 12. Alternatively, the fireplace assembly 10 can have a different design than that illustrated in FIG. 1A.

As an overview, in certain embodiments, the fireplace assembly 10 is configured to be movable between an open configuration (as shown in FIG. 1A) wherein the electric fireplace 14 is visible and can be freely used by a user, and a closed configuration (as shown in FIG. 1B) wherein the electric fireplace 14 is hidden from view and cannot be used by the user. Additionally, in various embodiments, the fireplace assembly 10 is designed to include fireplace doors 16 (illustrated in FIG. 1B) that are selectively positionable between a stored position (as shown in FIG. 1A) where the fireplace doors 16 are stored away and/or hidden from view, and a closed position (as shown in FIG. 1B) where the fireplace doors 16 are positioned to obscure the electric fireplace from view. In particular, the stored position for the fireplace doors 16 coincides with the open configuration for the fireplace assembly 10, and the closed position for the fireplace doors 16 coincides with the closed configuration for the fireplace assembly 10.

The assembly housing 12 can have any suitable design and can be further utilized for any suitable purposes. For example, in the embodiment illustrated in FIG. 1A, the assembly housing 12 can be in the general form of an entertainment center, which can have any desired number of retaining members 18, e.g., compartments, drawers, shelves and surfaces, for purposes of supporting and/or retaining a plurality of multimedia devices 20 or other objects or materials. Additionally, any of the retaining members 18, e.g., compartments, drawers and/or shelves, can be selectively covered by one or more assembly doors 22. As shown in FIG. 1A, the assembly housing 12 can be used to support and/or retain multimedia devices 20 such as a television, a DVR and a DVD player. Additionally, the assembly housing 12 can be used to support other types of devices.

Further, the assembly housing 12 can be formed from any suitable materials. In various embodiments, the assembly housing 12 can be formed from any of a number of suitable wood materials. Additionally and/or alternatively, as shown, any of the assembly doors 22 can include and/or incorporate glass materials. In certain embodiments, the glass materials utilized within the assembly doors 22 can be transparent to better enable the user to see what is being retained within the compartments, drawers or shelves behind the assembly doors 22. Still alternatively, the assembly housing 12 can be formed from other suitable materials and/or the assembly housing 12 can be used for other suitable purposes.

As illustrated herein, the electric fireplace 14 can be used to provide heat and to simulate a wood burning fire, e.g., in the room of a home or other type of building. More particularly, in certain embodiments, the electric fireplace 14 can be configured to look like a traditional wood burning fireplace, although the electric fireplace 14 does not actually burn wood.

As noted above, in this embodiment, the electric fireplace 14 is positioned substantially within the assembly housing 12. The design of the electric fireplace 14 can be varied to suit the specific requirements of the fireplace assembly 10. As shown, in various embodiments, the electric fireplace 14 can include a fireplace housing 24, a viewing area 26 within the fireplace housing 24, a simulated flame 28 (i.e. when the electric fireplace 14 is in use), one or more simulated logs 30, a grate 32, a heater 34 and a controller 36. Alternatively, the electric fireplace 14 can include more components or fewer components than those specifically illustrated in FIG. 1A. For example, in one non-exclusive alternative embodiment, the electric fireplace 14 can be designed without the heater 34.

The fireplace housing 24 can be sized and shaped to retain most, if not all, of the remaining components of the electric fireplace 14. In particular, as shown, the simulated flame 28 (i.e. when the electric fireplace 14 is in use), the one or more simulated logs 30, the grate 32, the heater 34 and the controller 36 can be positioned substantially within the fireplace housing 24. In some embodiments, the fireplace housing 24 has a substantially rectangular shape. Additionally, the fireplace housing 24 can further include a window (not shown) located at a front side of the fireplace housing 24. The window can be a tempered glass or a meshed door through which the simulated flame 28 can be seen. Alternatively, the fireplace housing 24 can have a different shape and/or the fireplace housing 24 can be designed without the window.

Additionally, the fireplace housing 24 can be formed from any suitable materials. For example, in various embodiments, the fireplace housing 24 can be formed from any of a number of suitable metallic materials.

The viewing area 26 is the area within the fireplace housing 24 in which the simulated flame 28, the simulated logs 30 and the grate 32 are displayed and can be seen by the user.

The simulated flame 28 can be formed from any suitable method. For example, in various embodiments, the electric fireplace 14 can utilize a light source 37 (illustrated as a box in phantom) to illuminate a reflective medium, e.g., a suitable metal material, to generate the simulated flame 28, i.e. a flickering flame image. The light source 37 can have any suitable design. For example, in one non-exclusive alternative embodiment, the light source 37 can include an LED panel having one or more LED light bulbs. Alternatively, the light source 37 can include other types of light bulbs or another type of light source. As noted and as shown in FIG. 1A, in various embodiments, the simulated flame 28 is displayed within the viewing area 26 of the electric fireplace 14.

Additionally and as noted above, the simulated (or artificial) logs 30 can also be positioned within the viewing area 26. The combination of the simulated logs 30 and the simulated flame 28 generate the appearance of burning logs, thereby closely simulating the flames of a wood burning fireplace. As illustrated, the simulated logs 30 can further be placed on top of the grate 32, i.e. an actual or a simulated grate. Simulated embers (not shown) in the form of a simulated emberbed may also be used to enhance the effect of the simulated flame 28.

Further, the heater 34, e.g., an integrated electric heater, can be configured to provide heated air which can be directed in a generally outward direction away from the electric fireplace 14. More particularly, in certain embodiments, the heater 34 can include a blower (not shown) that blows hot air through heat vents 38 into the area surrounding the electric fireplace, e.g., a room in a house, in order to heat such area. In some such embodiments, the heat vents 38 can be positioned at or near an upper portion of the fireplace housing 24.

The controller 36 can include one or more circuits or processors that can be utilized to control the various functions of the electric fireplace 14. For example, the controller 36 can be utilized to activate and/or control (i) the intensity of the light source 37 within the electric fireplace 14 that generates the simulated flame 28, and (ii) the speed of the blower within the heater 34 to regulate the amount of heat produced and dispersed by the heater 34.

FIG. 1B is another front perspective view of the electric fireplace assembly 10 illustrated in FIG. 1A. Additionally, as noted above, the fireplace assembly 10 as shown in FIG. 1B is in the closed configuration. More specifically, when in the closed configuration, the fireplace doors 16 of the electric fireplace 14 (shown more clearly in FIG. 1A) are positioned such that the various components of the electric fireplace 14, e.g., including the simulated logs 30 (illustrated in FIG. 1A) and the grate 32 (illustrated in FIG. 1A), are hidden from view. It should be appreciated that when the fireplace assembly 10 is in the closed configuration, the electric fireplace 14 will likely not be in use and, thus, will likely not be generating the simulated flame 28 (illustrated in FIG. 1A).

Additionally, it should be appreciated that the number of fireplace doors 16 can be varied. For example, in this embodiment, the fireplace assembly 10 includes two fireplace doors 16, i.e. a first fireplace door 16A and a second fireplace door 16B. In this embodiment, the fireplace doors 16A, 16B are sized and shaped to cover the front of the fireplace assembly 10. Alternatively, the fireplace assembly 10 can include greater than two fireplace doors 16 or only one fireplace door 16.

Further, the fireplace doors 16 can be coupled to the fireplace housing 24 (illustrated in FIG. 1A) in any suitable method. For example, in one non-exclusive alternative embodiment, the fireplace doors 16 can be effectively free-floating and can be magnetically (and removably) coupled, e.g., with one or more magnets 40 (illustrated, for example, in FIG. 1D) that are secured to a back 41 (illustrated in FIG. 1D) of each of the fireplace doors 16A, 16B, to the metallic materials that are used to form the fireplace housing 24 (illustrated in FIG. 1A). Alternatively, the fireplace housing 24 can also include one or more magnetically permeable regions (not shown) to provide the magnetic coupling with the magnets 40 on the back 41 of the fireplace doors 16A, 16B. Still alternatively, the fireplace doors 16 can be coupled to the fireplace housing 24 with one or more hinges. Yet alternatively, the fireplace doors 16 can be coupled to the fireplace housing 24 in a different manner.

As shown in this embodiment, each of the fireplace doors 16A, 16B can be positioned substantially directly in front of various components of the electric fireplace 14, e.g., the simulated logs 30 and the grate 32, to obscure a view of such components when the fireplace assembly 10 is in the closed configuration. As such, when the fireplace assembly 10 is in the closed configuration, the fireplace doors 16A, 16B can be said to be positioned in the closed position.

Returning briefly to FIG. 1A, it should be understood that in this embodiment, the fireplace doors 16 (illustrated in FIG. 1B) cannot be seen when the fireplace assembly 10 is in the open configuration. More specifically, the fireplace doors 16 have been selectively obscured or hidden from view within the assembly housing 12 when the fireplace assembly 10 is in the open configuration. As such, when the fireplace assembly 10 is in the open configuration, the fireplace doors 16A, 16B (illustrated in FIG. 1B) can be positioned in the stored position.

FIGS. 1C-1E illustrate front perspective views of the fireplace assembly 10 at various points as the fireplace assembly 10 is converted from the closed configuration to the open configuration, and as the fireplace doors 16A, 16B are moved from the closed position to the stored position.

It should be appreciated that the fireplace doors 16A, 16B can be moved between the closed position, (i.e. when the fireplace doors 16A, 16B are obscuring the various components positioned within the fireplace housing 24 of the electric fireplace 14 and the fireplace assembly 10 is in the closed configuration), and the stored position, (i.e. when the fireplace doors 16A, 16B are stored away and/or hidden from view and the fireplace assembly 10 is in the open configuration), in any suitable manner. For example, in the embodiment where the fireplace doors 16A, 16B are free-floating and are magnetically coupled to the fireplace housing 24, the fireplace doors 16A, 16B can be manually fully removed from the fireplace housing 24 and stored within the fireplace assembly 10. Alternatively, a series of hinges and guides can be utilized that enables the selective movement of the fireplace doors 16A, 16B between the closed position and the stored position; and, thus, enables the selective movement of the fireplace assembly 10 between the closed configuration and the open configuration.

Referring initially to FIG. 1C, it is shown that in this embodiment, the fireplace assembly 10 includes one or more assembly cavities 42 (two are shown in FIG. 1C) that are defined by a portion of the assembly housing 12 being spaced apart from the fireplace housing 24. For example, as illustrated in FIG. 1C, in some embodiments, (i) the fireplace housing 24 can have a first side 24A that is spaced apart from the assembly housing 12 to define a first assembly cavity 42A, and (ii) the fireplace housing 24 can have a second side 24B that is spaced apart from the assembly housing 12 to define a second assembly cavity 42B. In this embodiment, each assembly cavity 42A, 42B is relatively long (vertically), relatively narrow (horizontally), and deep (into the assembly). With this design, each assembly cavity 42A, 42B is sized and shaped to fully receive one of the planar doors 16A, 16B.

Moreover, as illustrated in FIG. 1C, the fireplace assembly 10 can include one or more cavity doors 44 (two are shown in FIG. 1C) that are movably, e.g., hingedly, coupled to the assembly housing 12 adjacent to the assembly cavities 42. The cavity doors 44 can be selectively opened and closed to selectively reveal and obscure the assembly cavities 42. In particular, as shown, the assembly housing 12 can include (i) a first cavity door 44A that can be selectively opened and closed to selectively reveal and obscure the first assembly cavity 42A; and (ii) a second cavity door 44B that can be selectively opened and closed to selectively reveal and obscure the second assembly cavity 42B.

It should be appreciated that during this initial step of opening the cavity doors 44A, 44B to reveal the assembly cavities 42A, 42B formed within the assembly housing 12 substantially if not directly adjacent to the fireplace housing 24, the fireplace doors 16A, 16B are still closed in a manner to obscure the various components of the electric fireplace 14. Alternatively, it should also be appreciated that the fireplace doors 16A, 16B can be moved from the closed position prior to the cavity doors 44A, 44B being opened to reveal the assembly cavities 42A, 42B, respectively.

Referring next to FIG. 1D, the fireplace doors 16A, 16B have been opened to selectively reveal the various internal components of the electric fireplace 14, i.e. the simulated flame 28 (if being generated), the simulated logs 30, the grate 32, the heater 34 and the controller 36. Additionally, at this point the fireplace doors 16 have been started to be pushed back and/or slid back into the assembly cavities 42. More specifically, each of the two fireplace doors 16 is being pushed back and/or slid back into one of the assembly cavities 42 such that the fireplace doors 16 can be stored within the assembly cavities 42 during use of the electric fireplace 14. In particular, the first fireplace door 16A can be pushed back and/or slid back into the first assembly cavity 42A, and the second fireplace door 16B can be pushed back and/or slid back into the second assembly cavity 42B.

As noted above, it should be appreciated that the fireplace doors 16 can be moved between the closed position, when the fireplace doors 16 are obscuring the various components within the electric fireplace 14, and the stored position, when the fireplace doors 16 are stored within the assembly cavities 42, in any suitable manner. For example, in the embodiment where the fireplace doors 16A, 16B are free-floating and are magnetically coupled to the fireplace housing 24, the fireplace doors 16A, 16B can be manually moved and positioned within the assembly cavities 42A, 42B. Alternatively, series of hinges can enable the fireplace doors 16 to pivot relative to the fireplace housing 24, and then a series of guides can enable the fireplace doors 16A, 16B to be slid along the guides and into the assembly cavities 42A, 42B. Still alternatively, the fireplace doors 16A, 16B can be moved between the closed position and the stored position in a different manner.

FIG. 1E, as noted above, is another front perspective view of the fireplace assembly 10. In FIG. 1E, the fireplace assembly 10 has been moved still farther from the closed configuration toward the open configuration. More specifically, in FIG. 1E, the fireplace doors 16 are no longer clearly visible as the fireplace doors 16 have been pushed back and/or slid back fully within the assembly cavities 42, i.e. with one fireplace door 16 within each assembly cavity 42A, 42B. FIG. 1E illustrates the fireplace doors 16 in such position while the cavity doors 44A, 44B are still open. It should be understood that this situation with the cavity doors 44A, 44B being opened while the fireplace doors 16 are still positioned within the assembly cavities 42A, 42B can also be an initial step in the movement of the fireplace assembly 10 from the open configuration toward the closed configuration, and the movement of the fireplace doors 16A, 16B from the stored position to the closed position.

Returning now to FIG. 1A, the cavity doors 44 have again been fully closed with the fireplace doors 16 (illustrated in FIG. 1B) being positioned fully within the assembly cavities 42 (illustrated in FIG. 1C). Thus, the fireplace assembly 10 has now been moved fully to the open configuration (and the fireplace doors 16 have been moved fully to the stored position), and the electric fireplace 14 is ready for use.

Thus, the present invention provides easy storage for the fireplace door 16 when not in use. Thus, the fireplace can be easily moved between the open configuration and the closed configuration.

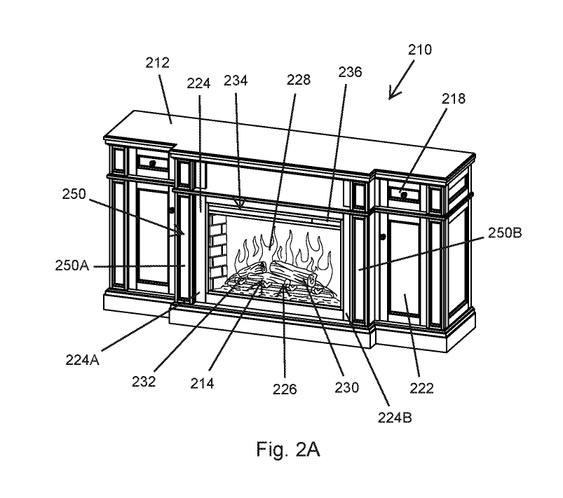

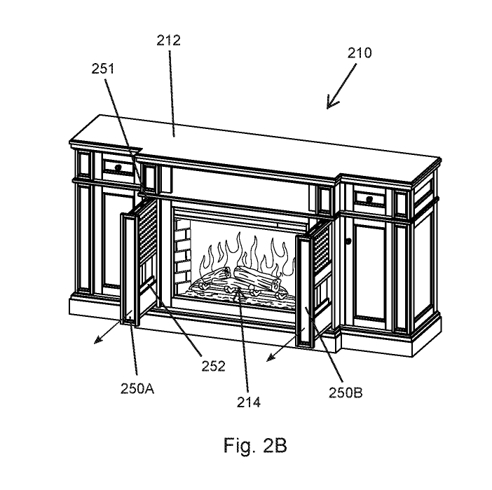

FIG. 2A is a front perspective view of another embodiment of the electric fireplace assembly 210 having features of the present invention. The fireplace assembly 210 is somewhat similar to the embodiments illustrated and described above. For example, in certain embodiments, the fireplace assembly 210 again includes an assembly housing 212 and an electric fireplace 214 that is positioned substantially within the assembly housing 212.

Additionally, the electric fireplace 214 again includes many of the components illustrated and described in detail herein above. In particular, the electric fireplace 214 again includes a fireplace housing 224, a viewing area 226, a simulated flame 228, one or more simulated logs 230, a grate 232, a heater 234, and a controller 236 that are substantially similar to what was illustrated and described above. Accordingly, such features will not again be described in detail.

Further, the assembly housing 212 again includes any desired number of retaining members 218, e.g., compartments, drawers, shelves and surfaces, for purposes of supporting and/or retaining a plurality of multimedia devices 20 (illustrated in FIG. 1A) or other objects or materials. Additionally, any of the retaining members 218, e.g., compartments, drawers and/or shelves, can be selectively covered by one or more assembly doors 222. However, in this embodiment, the assembly housing 212 includes at least one vertically-oriented assembly drawer 250 that can be positioned substantially directly adjacent to the fireplace housing 224. More particularly, as shown in FIG. 2A, the assembly housing 212 includes a vertically-oriented first assembly drawer 250A that is positioned substantially directly adjacent to the first side 224A of the fireplace housing 224, and a vertically-oriented second assembly drawer 250B that is positioned substantially directly adjacent to the second side 224B of the fireplace housing 224. As shown in FIG. 2A, the assembly drawers 250A, 250B are in a closed position.

As utilized herein, the term “vertically-oriented” with regard to the assembly drawers 250A, 250B is intended to signify that the front face of the drawers 250A, 250B is longer in the vertical direction than in the horizontal direction. Stated in another manner, the assembly drawers 250A, 250B are taller than they are wide. This size restriction is applicable regardless of the front-to-back depth of the assembly drawers 250A, 250B.

FIG. 2B is another front perspective view of the electric fireplace assembly 210 illustrated in FIG. 2A. In particular, FIG. 2B illustrates the fireplace assembly 210 with the assembly drawers 250A, 250B having been pulled out into an extended position so as to provide access to the interior of the assembly drawers 250A, 250B. More particularly, each of the assembly drawers 250A, 250B can include one or more guides 251 that guide the movement of the assembly drawers 250A, 250B between the extended position (as illustrated in FIG. 2B) and a closed position (as illustrated in FIG. 2A).

The interior of the assembly drawers 250A, 250B can have any suitable design, and can be configured to retain any number of suitable objects 252. For example, in some non-exclusive alternative embodiments, the assembly drawers 250A, 250B can include slots, holes, hooks, shelves, etc. that can be utilized for retaining any suitable objects 252.

It should be appreciated that the objects 252 that can be stored within the assembly drawers 250A, 250B can relate to the overall function of the fireplace assembly 210 and/or the assembly housing 212. For example, if the assembly housing 212 is in the general form of an entertainment center, the assembly drawers 250A, 250B can be configured to retain objects 252 such as CDs, DVDs, remote controls, batteries, etc. Additionally, the assembly drawers 250A, 250B can also retain objects 252 for use with the electric fireplace 214 such as remote controls, batteries, light bulbs and any necessary replacement parts.

It is understood that although a number of different embodiments of the electric fireplace assembly 10 have been illustrated and described herein, one or more features of any one embodiment can be combined with one or more features of one or more of the other embodiments, provided that such combination satisfies the intent of the present invention.

While a number of exemplary aspects and embodiments of an electric fireplace assembly 10 have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. An electric fireplace assembly that is selectively movable between an open configuration and a closed configuration, the electric fireplace assembly comprising:
an assembly housing; and
an electric fireplace that is positioned substantially within the assembly housing, the electric fireplace including (i) a fireplace housing having a first side that is spaced apart from the assembly housing to define a first assembly cavity; (ii) a simulated log that is positioned within the fireplace housing; and (iii) a first fireplace door that is coupled to the fireplace housing;
wherein the first fireplace door is positioned substantially directly in front of the simulated log to obscure a view of the simulated log when the electric fireplace assembly is in the closed configuration; and
wherein the first fireplace door is positioned within the first assembly cavity when the electric fireplace assembly is in the open configuration.

2. The electric fireplace assembly of claim 1 further comprising a first cavity door that is movably coupled to the assembly housing adjacent to the first assembly cavity.

3. The electric fireplace assembly of claim 2 wherein the first cavity door can be closed such that the first fireplace door is hidden from view when the electric fireplace assembly is in the open configuration.

4. The electric fireplace assembly of claim 1 wherein the fireplace housing has a second side that is spaced apart from the assembly housing to define a second assembly cavity.

5. The electric fireplace assembly of claim 4 wherein the electric fireplace further includes a second fireplace door that is coupled to the fireplace housing; wherein the second fireplace door is positioned substantially directly in front of the simulated log to obscure a view of the simulated log when the electric fireplace assembly is in the closed configuration; and wherein the second fireplace door is positioned within the second assembly cavity when the electric fireplace assembly is in the open configuration.

6. The electric fireplace assembly of claim 5 further comprising a second cavity door that is movably coupled to the assembly housing adjacent to the second assembly cavity; and wherein the second cavity door can be closed such that the second fireplace door is hidden from view when the electric fireplace assembly is in the open configuration.

7. The electric fireplace assembly of claim 1 wherein the first fireplace door is removably coupled to the fireplace housing.

8. The electric fireplace assembly of claim 1 further comprising a magnet that is secured to a back of the first fireplace door such that the first fireplace door can be magnetically coupled to the fireplace housing when the electric fireplace assembly is in the closed configuration.

9. The electric fireplace assembly of claim 1 wherein the electric fireplace further includes a heater that is positioned within the fireplace housing, the heater being configured to provide heated air which can be directed in a generally outward direction away from the fireplace housing.

10. The electric fireplace assembly of claim 1 wherein the electric fireplace further includes a light source that is positioned within the fireplace housing, the light source being configured to generate a simulated flame within the fireplace housing.

11. The electric fireplace assembly of claim 1 wherein the assembly housing includes a vertically-oriented assembly drawer.

12. The electric fireplace assembly of claim 11 wherein the assembly drawer is positioned substantially directly adjacent to the fireplace housing.

13. An electric fireplace assembly comprising:
an assembly housing including a vertically-oriented first assembly drawer; and
an electric fireplace that is positioned substantially within the assembly housing, the electric fireplace including (i) a fireplace housing having a first side; and (ii) a simulated log that is positioned within the fireplace housing; and
wherein the first assembly drawer is positioned substantially directly adjacent to the first side of the fireplace housing.

14. The electric fireplace assembly of claim 13 wherein the assembly housing includes a vertically-oriented second assembly drawer; wherein the fireplace housing has a second side; and wherein the second assembly drawer is positioned substantially directly adjacent to the second side of the fireplace housing.

15. The electric fireplace assembly of claim 13 wherein the electric fireplace further includes a first fireplace door that is coupled to the fireplace housing, the first fireplace door being selectively positionable to obscure a view of the simulated log when the electric fireplace assembly is in a closed configuration.

16. The electric fireplace assembly of claim 15 wherein the electric fireplace further includes a second fireplace door that is coupled to the fireplace housing, the second fireplace door being selectively positionable to obscure a view of the simulated log when the electric fireplace assembly is in the closed configuration.

17. The electric fireplace assembly of claim 13 wherein the electric fireplace further includes a heater that is positioned within the fireplace housing, the heater being configured to provide heated air which can be directed in a generally outward direction away from the fireplace housing.

18. The electric fireplace assembly of claim 13 wherein the electric fireplace further includes a light source that is positioned within the fireplace housing, the light source being configured to generate a simulated flame within the fireplace housing.
